(19) United States
(12) Patent Application Publication
(10) Pub. No.: US 2026/0290982 A1
(43) Pub. Date: Sep. 24, 2026

(54) BATTERY PACK AND ITS MANUFACTURING METHOD

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,143

(22) PCT Filed: Apr. 13, 2023
(86) PCT No.: PCT/CN2023/088029

§ 371 Date: Oct. 9, 2025

(51) Int. Cl. H01M 50/287; H01M 50/247

(52) U.S. Cl. CPC H01M 50/287; H01M 50/247; H01M 2220/30

(57) ABSTRACT

A battery pack for an electrical device including a housing defining a cavity and a plurality of ribs that extend inward toward the cavity. The battery pack further includes a plurality of battery cells disposed within the cavity and configured to supply power to the electrical device, a support structure configured to receive and support the plurality of battery cells within the cavity of the housing, and a circuit board disposed within the housing atop the support structure. The circuit board includes a plurality of electrical components and is configured to selectively power the plurality of battery cells. The battery pack further includes a battery cell potting that encases the plurality of battery cells and the support structure. The battery cell potting includes a plurality of grooves that mate with the plurality of ribs of the housing to inhibit movement of the plurality of battery cells relative to the housing.

### FIELD OF THE DISCLOSURE

The present disclosure relates to battery packs, and more particularly, to potting for battery cells within battery packs.

### SUMMARY

Power tools may be powered by portable battery packs. These battery packs range in battery chemistry and nominal voltage, and can be used to power numerous tools and electrical devices. Battery packs often include more than one battery cell that are located and organized within a housing of the battery pack.

In one aspect, the disclosure provides a battery pack for an electrical device including a housing defining a cavity and having at least one terminal configured to electrically connect the battery pack to the electrical device and a plurality of ribs that extend inward toward the cavity. The battery pack further includes a plurality of battery cells disposed within the cavity of the housing and configured to supply power to the electrical device, a support structure configured to receive and support the plurality of battery cells within the cavity of the housing, and a circuit board disposed within the housing atop the support structure. The circuit board includes a plurality of electrical components and is configured to selectively power the plurality of battery cells. The battery pack further includes a battery cell potting that encases the plurality of battery cells and the support structure. The battery cell potting includes a plurality of grooves that mate with the plurality of ribs of the housing to inhibit movement of the plurality of battery cells relative to the housing.

In one aspect, the battery cell potting is formed of one of polyurethane, acrylic, epoxy resin, and silicone. In one aspect, the battery cell potting is formed of a combination of at least two of polyurethane, acrylic, epoxy resin, and silicone. In one aspect, the combination of at least two of polyurethane, acrylic, epoxy resin, and silicone is a compound mixture of the at least two of polyurethane, acrylic, epoxy resin, and silicone. In one aspect, each of the plurality of battery cells is a cylindrical lithium-ion battery cell. In one aspect, the support structure includes a first end casing and a second end casing, wherein a positive electrode of each battery cell is received in one of the first end casing and the second end casing, and wherein a negative electrode of each battery cell is received in the other of the first end casing and the second casing. In one aspect, the plurality of battery cells are stacked in an offset manner along a height and a length of the battery pack, such that the plurality of battery cells defines rows of cells and columns of cells. In one aspect, the battery cell potting is only disposed between rows of cells, or only disposed between columns of cells. In one aspect, the battery cell potting also encases the circuit board. In one aspect, further comprising voids between adjacent battery cells of the plurality of the battery cells. In one aspect, the battery cell potting separates the battery cells.

In another aspect, the disclosure provides a battery pack for an electrical device includes a housing having a first housing portion, a second housing portion coupled to the first housing portion, a cavity, and at least one terminal configured to electrically connect the battery pack to the electrical device. The battery pack further includes a battery cell assembly including a plurality of battery cells disposed within the cavity and configured to supply power to the electrical device, a support structure that receives and support the plurality of battery cells within the cavity of the housing, and a battery cell potting that encases the plurality of battery cells and the support structure. The battery pack further includes a circuit board disposed within the housing atop the plurality of battery cells and including a plurality of electrical components. The circuit board is configured to selectively power the plurality of battery cells. The circuit board is coupled to the battery cell assembly.

In one aspect, the battery cell potting is formed of one of polyurethane, acrylic, epoxy resin, and silicone. In one aspect, the battery cell potting is formed of a combination of at least two of polyurethane, acrylic, epoxy resin, and silicone. In one aspect, the combination of at least two of polyurethane, acrylic, epoxy resin, and silicone is a compound mixture of the at least two of polyurethane, acrylic, epoxy resin, and silicone. In one aspect, each of the plurality of battery cells is a cylindrical lithium-ion battery cell. In one aspect, the support structure includes a first end casing and a second end casing, and wherein the circuit board is coupled to at least one of the first end casing and the second end casing.

In another aspect, the disclosure provides a method of manufacturing a battery pack for a power tool. The battery pack includes a housing having a first housing portion and a second housing portion that has a plurality of ribs that extend inward toward a cavity of the housing, a battery cell assembly disposed within the cavity of the housing having a plurality of battery cells and a support structure supporting the plurality of battery cells, and a circuit board positioned atop the battery cell assembly within the housing. The method includes injecting battery cell potting around the plurality of battery cells and the support structure, such that the plurality of battery cells and the support structure are coupled together via the battery cell potting, forming a plurality of grooves within the battery cell potting that are configured to receive the plurality of the ribs of the housing, and sliding the plurality of grooves along the plurality of ribs to secure the battery cell assembly within the cavity and inhibiting movement of the plurality of battery cells relative to the housing. In one aspect, further comprising composing the battery cell potting of a thermal curing adhesive that provides a heat dissipating medium between the plurality of battery cells. In one aspect, further comprising forming a plurality of voids between adjacent battery cells of the plurality of battery cells.

Other aspects of the disclosure will become apparent by consideration of the detailed description and accompanying drawings.

### BRIEF DESCRIPTION OF THE DRAWINGS

FIG. 1 is a perspective view of a battery pack according to an embodiment of the invention.

FIG. 2 is an exploded view of the battery pack of FIG. 1, illustrating a housing and a battery cell assembly disposed within the housing, according to some embodiments.

FIG. 3 is a cross-sectional view of the battery cell assembly along line 3-3 of FIG. 2, according to some embodiments.

FIG. 4 is an exploded perspective view of the battery cell assembly of FIG. 3, according to some embodiments.

FIG. 5 is a cross-sectional view of the battery cell assembly along line 3-3 of FIG. 2 according to another embodiment of battery pack.

FIG. 6 is a cross-sectional view of the battery cell assembly along line 3-3 of FIG. 2 according to yet another embodiment of battery pack.

FIG. 7 is a cross-sectional view of the battery cell assembly along line 3-3 of FIG. 2 according to still yet another embodiment of battery pack.

FIG. 8 is a cross-sectional view of the battery cell assembly along line 3-3 of FIG. 2 according to still yet another embodiment of battery pack.

FIG. 9 is a cross-sectional view of the battery cell assembly along line 3-3 of FIG. 2 according to still yet another embodiment of battery pack.

FIG. 10 is a cross-sectional view of the battery cell assembly along line 3-3 of FIG. 2 according to still yet another embodiment of battery pack.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

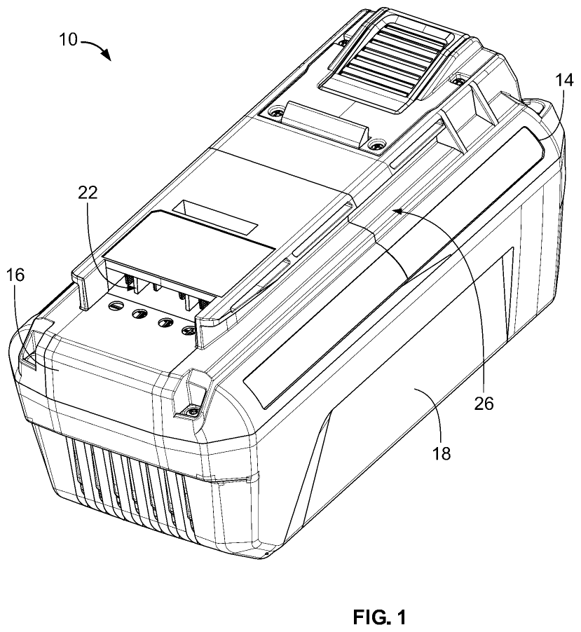

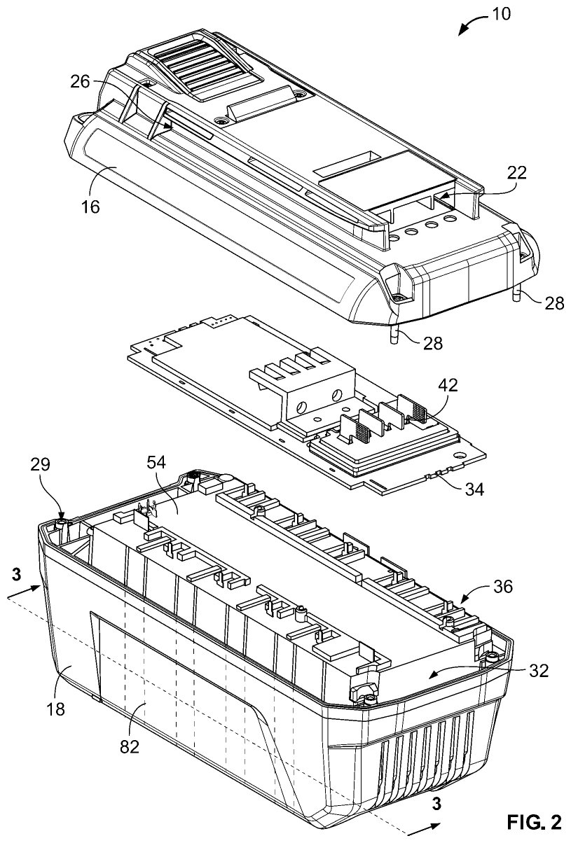

FIGS. 1 and 2 illustrate a battery pack 10 according to some embodiments. The battery pack 10 is connectable and operable to power electrical equipment, such as, hand-held power tools (e.g., drills, fasteners, saws, pipe cutters, sanders, nailers, staplers, vacuum cleaners, etc.), motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, riding lawn mower etc.), other motorized devices (e.g., vehicles, utility carts, a material handling cart, etc.), and non-motorized electrical devices (e.g., a power source, a light, an AC/DC adapter, a generator, personal electronic device, etc.), any one of which may now be referred to herein as “electrical device.” Still, in other embodiments, the battery pack 10 is connectable and operable to power other electrical devices. The battery pack 10 is removable from the electrical device and is rechargeable by a battery charger (not shown).

The battery pack 10 includes a battery chemistry such as, lead-acid, Nickel-cadmium (“NiCd”), Nickel-Metal Hydride (“NiMH”), Lithium (“Li”), Lithium-ion (“Li-ion”), other Lithium-based chemistry, or other rechargeable or non-rechargeable battery chemistry. In some embodiments, the battery pack 10 can have a battery chemistry of Li, Li-ion, or another Li-based chemistry and can supply an average discharge current that is equal to or greater than approximately 20 A. In one example, the battery pack 10 can have a chemistry of Lithium Cobalt (“Li—Co”), Lithium Manganese (“Li—Mn”) Spinel, Li—Mn Nickel, or other lithium metal chemistry.

The battery pack 10 includes a nominal voltage. In some embodiments, the battery pack 10 can have a nominal voltage of approximately 9.6 V. In other embodiments, the battery pack 10 can have a nominal voltage up to approximately 50 V. In some embodiments, the battery pack 10 can have a nominal voltage of approximately 21 V. In other embodiments, the battery pack 10 can have a nominal voltage of approximately 28 V. Still, in other embodiments, the battery pack 10 can have a nominal voltage, such as, 12 V, 14.4 V, 18 V, 24 V, 40 V, or 80 V to power the electrical device and be charged by the battery charger (not shown).

With continued reference to FIGS. 1 and 2, the battery pack 10 includes a housing 14 having a first housing portion 16 and a second housing portion 18. With reference to the orientation of the battery pack 10 illustrated in FIGS. 1 and 2, the first housing portion 16 is an upper housing portion, and the second housing portion 18 is a lower housing portion. The battery pack 10 further includes an electrical interface 22 that is configured to electrically connect to the electrical device and a locking mechanism 26 that is configured to selectively couple the battery pack 10 to the electrical device. The first housing portion 16 and the second housing portion 18 of the housing 14 are coupled together via a plurality of fasteners 28. An O-ring (not shown) is disposed at the interface between the first housing portion 16 and the second housing portion 18 to inhibit dirt and other debris from entering the housing 14. Specifically, the O-ring is partially received within a groove 29 that extends around the periphery of the second housing portion 18 and is further received within a corresponding groove (not shown) that extends around the periphery of the first housing portion 16 when the first and second housing portions 16, 18 are coupled together. As such, the first housing portion 16 and the second housing portion 18 define a cavity 32 having an internal volume. Although fasteners 28 are used to couple the first and second housing portion 16, 18 together in the illustrated embodiment, in other embodiments, the first housing portion 16 and the second housing portion 18 of the housing 14 can be coupled together via adhesives, tapes, fasteners, tabs, or any combination thereof.

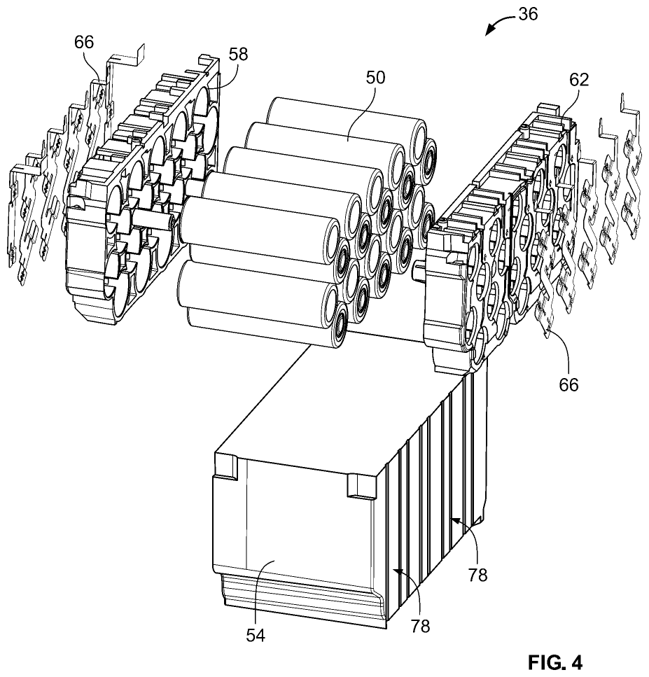

The battery pack 10 further includes a printed circuit board assembly (PCBA) 34 and a battery cell assembly 36, which are received in the cavity 32 of the housing 14. The PCBA 34 is disposed within the cavity 32 between the battery cell assembly 36 and the first housing portion 16. The PCBA 34 includes one or more terminals 42 that extends through the electrical interface 22 of the first housing portion 16 when the battery pack 10 is assembled. The battery cell assembly 36 may be disposed in and secured to the second housing portion 18. When the battery pack 10 is assembled, the first housing portion 16 and the second housing portion 18 substantially encapsulate the battery cell assembly 36 within the cavity 32. The battery cell assembly 36 includes a support structure 46, a plurality of battery cells 50 supported by the support structure 46, and battery cell potting 54 (best illustrated in FIG. 4) that encases the support structure 46 and the plurality of battery cells 50. In some embodiments, the battery cell assembly 36 may further include an internal housing that receives the support structure 46 and the plurality of battery cells 50 prior to injection of the battery cell potting 54. The PCBA 34 is coupled to the battery cell assembly 36. In the illustrated embodiment, the battery cells 50 are cylindrical battery cells. However, in other embodiments, the battery cells 50 may be pouch cells, prismatic cells, or another suitable battery cells. As will be described in further detail below, the battery cell potting 54 (FIG. 4) is injected to provide improved heat dissipation and/or water proofing for the battery cell assembly 36.

With reference to FIG. 4, the support structure 46 includes a first end casing 58, a second end casing 62, and a plurality of busbars 66. The battery cell assembly 36 is configured to generate an electric current. In the illustrated embodiment, the battery cells 50 of the battery cell assembly 36 generate a direct current (i.e., DC) such that the battery pack 10 is configured to provide a direct current to a device. In other embodiments, the battery pack 10 may include an inverter such that the battery pack 10 is configured to provide an alternating current (i.e., AC) to the device. When the battery pack 10 is assembled, the first end casing 58 and the second end casing 62 become at least partially encased in the battery cell potting 54. The plurality of battery cells 50 extends between the first end casing 58 and the second end casing 62. Specifically, one end of each of the plurality of battery cells 50 is received in one of the first end casing 58 and the second end casing 62, and the other end of each of the plurality of battery cells 50 is received in the other one of the first end casing 58 and the second end casing 62. Furthermore, the battery cells 50 are stacked along a length L and a height H of the battery pack 10, where each row of battery cells 50 extending along the length L is offset from an adjacent row. Similarly, each column of battery cells 50 along the height H is offset from an adjacent column.

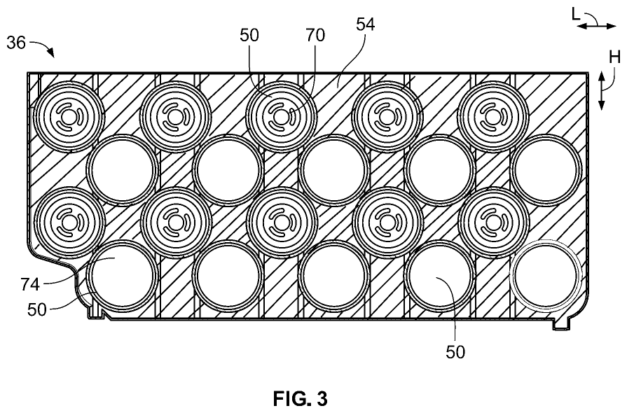

With reference to FIG. 3, each battery cell 50 has a positive electrode 70 at one end of the battery cell 50 and a negative electrode 74 at the other end of the battery cell 50. The battery cells 50 are arranged between the first end casing 58 and the second end casing 62 with an alternating electrode orientation. In the alternating electrode orientation, the positive electrode 70 of each battery cell 50 is disposed adjacent to the negative electrode 74 of an adjacent battery cell 50. The alternating electrode orientation provides the battery cell assembly 36 with a charge differential, and thus, enables the battery cell assembly 36 to generate the electric current.

Returning reference to FIG. 4, the plurality of busbars 66 is configured to electrically connect the battery cells 50 to each other. In the illustrated embodiment, the battery cell assembly 36 includes six busbars 66 electrically coupled to corresponding battery cells 50 at the first end casing 58 and six busbars 66 electrically coupled to corresponding battery cells 50 at the second end casing 62. However, in other embodiments, there may be more or fewer busbars 66 that electrically couple the battery cells 50 in a different configuration. The plurality of busbars 66 further connects the plurality of battery cells 50 to the PCBA 34 (FIG. 2) such that the electric current generated by the battery cells 50 may flow through the PCBA 34 to the output terminal 42 via the busbars 66.

With reference to FIGS. 2 and 3, in the illustrated embodiment, the battery cell potting 54 may substantially surround each of the battery cells 50. As such, the plurality of battery cells 50, the support structure 46, and the battery cell potting 54 fills a majority of the cavity 32. The battery cell potting 54 may provide a heat dissipating medium for heat generated by the battery cells 50 during use of the battery pack 10. That is, heat generated by the battery cells 50 may be transferred to and dissipated via the battery cell potting 54 rather than remaining in the ambient air of the housing 14 of the battery pack 10. As such, the battery cell potting 54 may reduce the temperature of the battery cells 50, thus reduce the internal temperature of the battery pack 10, and therefore, reduce failure of the battery pack 10 due to overheating.

The battery cell potting 54 additionally improves the water-proofing of the battery pack 10. Specifically, the battery cell potting 54 may reduce the amount of empty, or void, space within the cavity 32 of housing 14 such that water is inhibited from moving between or in proximity to the battery cells 50. Additionally, the material of the battery cell potting 54 may be waterproof and thus provide a water proof seal between the battery cells 50. By improving the waterproofing of the battery cell assembly 36, the battery cell potting 54 improves the ability of the battery pack 10 to withstand environmental ingress, and therefore, may improve the lifespan of the battery pack 10.

In the illustrated embodiment, the battery cell potting 54 may be formed of a thermal curing adhesive. Specifically, the battery cell potting 54 may be formed of one of polyurethane, acrylic, epoxy resin, silicone, or another similar compound. In some embodiments, the battery cell potting 54 may be formed of multiple compounds. That is, different battery cells 50 may be surrounded by different types of battery cell potting 54. For example, some of the battery cells 50 may be surrounded by battery cell potting 54 formed primarily of epoxy resin, and some of the battery cells 50 may be surrounded by battery cell potting 54 formed primarily of polyurethane. In further embodiments, the battery cell potting 54 may be a mixture that is formed with a combination of any of the compounds disclosed above. For example, the battery cell potting 54 may be formed of 50% acrylic and 50% silicone. In another example, the battery cell potting 54 may be formed of 33% polyurethane, 33% epoxy resin, and 33% silicone.

With reference to FIGS. 2 and 4, the battery cell potting 54 may be formed, or provided, through an injection molding process. The injection process includes injecting the battery cell potting 54 into a mold (not shown) with an injection tool such as, but not limited to, a syringe, a precision applicator, or another similar injection tool. Specifically, the battery cell potting 54 may be injected into the mold in liquid form and then eventually cured into solid form. The battery cells 50 and the support structure 46 may be placed into the mold prior to injecting the battery cell potting 54 such that the battery cell potting 54 cures around the battery cells 50 and the support structure 46, resulting in no voids in the battery cell assembly 36. The mold may be any shape/size and may form various features in the battery cell potting 54 as it cures. For example, a plurality of grooves 78 on the battery cell potting 54 may be formed during the injection molding process. Curing time may be variably dependent on the compound of the battery cell potting 54. Once the battery cell potting 54 is cured, the battery cell assembly 36 may be removed from the mold and assembled within the cavity 32 of the housing 14. In other embodiments, the battery cell assembly 36 with the mold may be placed within the housing 14. Specifically, each of the grooves 78 receive corresponding interior ribs 82 from the second housing portion 18 to secure the battery cell assembly 36 within the second housing portion 18, thereby inhibiting movement of the battery cell assembly 36 relative to the housing 14. In some embodiments, a setting agent may be mixed into the battery cell potting 54 to reduce curing time for the battery cell potting 54. That is, the battery cell potting 54 may be mixed with the setting agent directly prior to injection. Alternatively, the setting agent may be injected into the mold simultaneously or after the battery cell potting 54 has been injected into the mold.

In other embodiments, the support structure 46 and the plurality of battery cells 50 may be placed into the second housing portion 18, at which point the battery cell potting 54 is delivered (i.e., injected, poured, etc.) into the second housing portion 18 to fully encase the support structure 46 and the plurality of battery cells 50. In such an embodiment, the battery cell potting 54 floods and fully engages the second housing portion 18 and surrounds the support structure 46 and the plurality of battery cells 50 disposed therein. Also, in such an embodiment, there may be appropriate channeling provided within the second housing portion 18 for airflow to travel through the cavity 32 of the housing 14.

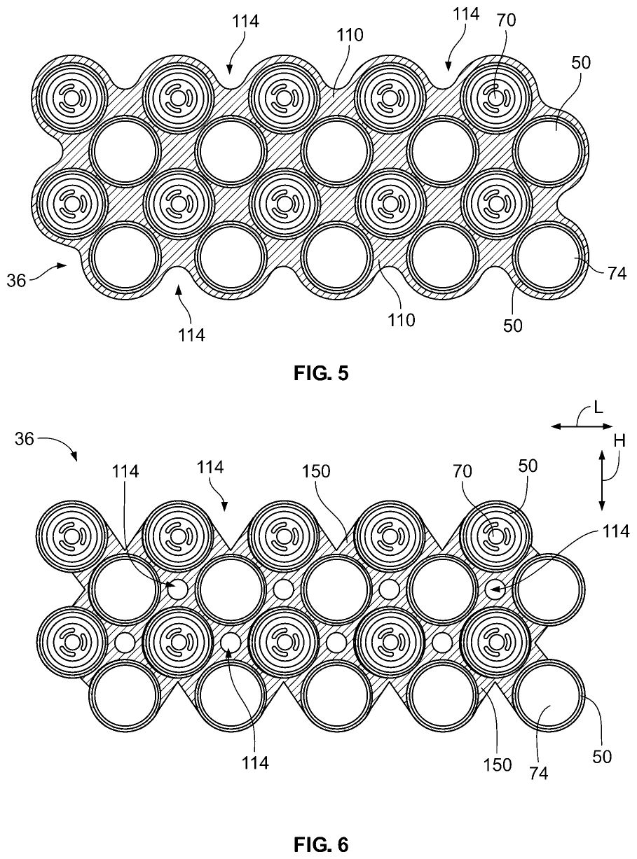

FIG. 5 illustrates another embodiment of battery cell potting 110 for the battery cell assembly 36. The battery cell potting 110 of FIG. 5 may be substantially similar to the battery cell potting 54 of FIG. 3, except for the differences described herein. The battery cell potting 110 of FIG. 5 is located around and substantially encapsulates each battery cell 50, but some voids 114 exist. Specifically, the voids 114 are located along an outer periphery of the battery cell assembly 36.

FIG. 6 illustrates another embodiment of battery cell potting 150 for the battery cell assembly 36. The battery cell potting 150 of FIG. 6 may be substantially similar to the battery cell potting 110 of FIG. 5, except for the differences described herein. The cell potting 150 of FIG. 6 is only disposed between adjacent battery cells 50 with voids 114 existing between rows and columns of the battery cells 50. That is, the battery cell potting 150 of FIG. 6 is provided in the space diagonally between each battery cell 50. The cell potting 150 does not encapsulate each battery cell 50. Specifically, the battery cells 50 that are located along an outer periphery of the battery cell assembly 36 are not completely encapsulated with cell potting 150 due to the voids 114. The voids 114 also exist between adjacent battery cells 50.

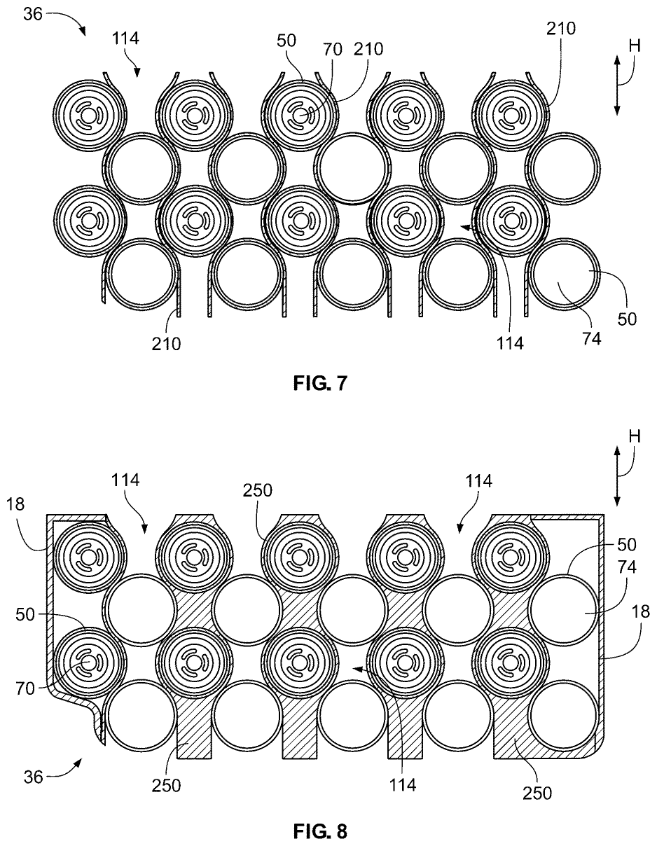

FIG. 7 illustrates another embodiment of cell potting 210 for the battery cell assembly 36. The cell potting 210 of FIG. 7 may be substantially similar to the cell potting 54 of FIG. 3, except for the differences described herein. The cell potting 210 of FIG. 7 is formed in strips that extend substantially along the height H of the battery pack 10. The cell potting 210 extends between adjacent columns of the battery cells 50. There are voids 114 between adjacent battery cells 50 along the height H.

FIG. 8 illustrates another embodiment of battery cell potting 250 for the battery cell assembly 36. The battery cell potting 250 of FIG. 8 may be substantially similar to the battery cell potting 210 of FIG. 7, except for the differences described herein. The battery cell potting 250 of FIG. 8 encases entire columns of battery cells 50 in an alternating manner. As such, one column of battery cells 50 that are encased by the battery cell potting 250 is adjacent to columns that are not encased by battery cell potting 250. As such, voids 114 exist in the columns without the cell potting 250.

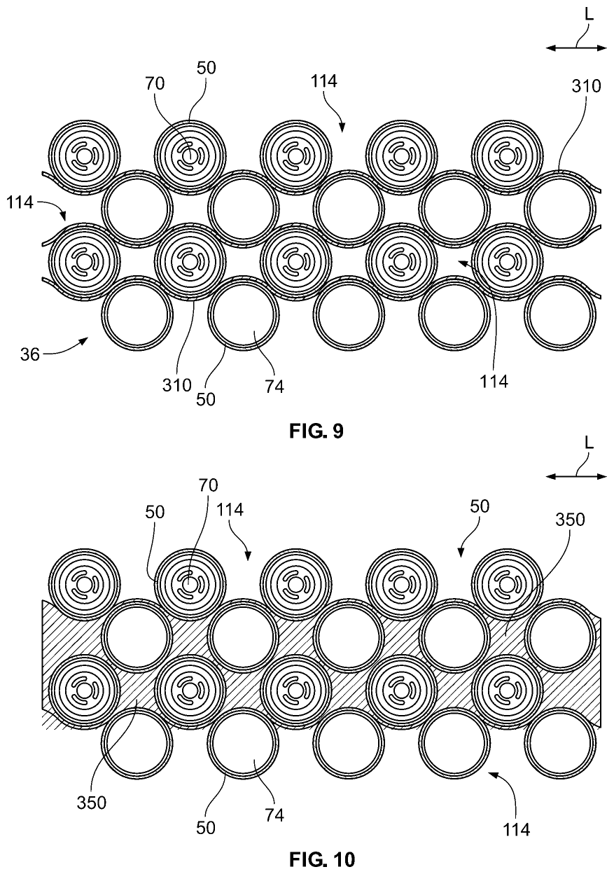

FIG. 9 illustrates another embodiment of battery cell potting 310 for the battery cell assembly 36. The battery cell potting 310 of FIG. 9 may be substantially similar to the battery cell potting 210 of FIG. 7, except for the differences described herein. The battery cell potting 310 of FIG. 9 is formed in strips that extend substantially along the length L of the battery pack 10. The cell potting 210 extends between adjacent rows of the battery cells 50. There are voids 114 between adjacent battery cells 50 along the length L.

FIG. 10 illustrates another embodiment of battery cell potting 350 for the battery cell assembly 36. The battery cell potting 350 of FIG. 10 may be substantially similar to the battery cell potting 310 of FIG. 9, except for the differences described herein. The battery cell potting 350 of FIG. 10 encases entire rows of the battery cells 50. In some embodiments, the battery cell potting 350 may encase rows of the battery cells 50 in an alternating manner. Some rows of the battery cells are not encased by the battery cell potting 350, so voids 114 exist in the rows without the battery cell potting 250.

It is understood that while each embodiment of the cell potting 54, 110, 150, 210, 250, 310, 350 is described for use with the battery cell assembly 36 separately from the other embodiments of the cell potting 54, 110, 150, 210, 250, 310, 350, the battery pack 10 may include any combination of the embodiments of the cell potting 54, 110, 150, 210, 250, 310, 350 disclosed herein.

Although particular embodiments have been shown and described, other alternative embodiments will become apparent to those skilled in the art and are within the intended scope of the independent aspects of the disclosure. Various features of the disclosure are set forth in the claims.

1. A battery pack for an electrical device, the battery pack comprising:
a housing defining a cavity and including at least one terminal configured to electrically connect the battery pack to the electrical device and a plurality of ribs that extend inward toward the cavity;
a plurality of battery cells disposed within the cavity of the housing and configured to supply power to the electrical device;
a support structure configured to receive and support the plurality of battery cells within the cavity of the housing;
a circuit board disposed within the housing atop the support structure and including a plurality of electrical components, the circuit board is configured to selectively power the plurality of battery cells; and
a battery cell potting that encases the plurality of battery cells and the support structure, the battery cell potting includes a plurality of grooves that mate with the plurality of ribs of the housing to inhibit movement of the plurality of battery cells relative to the housing.

2. The battery pack of claim 1, wherein the battery cell potting is formed of one of polyurethane, acrylic, epoxy resin, and silicone.

3. The battery pack of claim 1, wherein the battery cell potting is formed of a combination of at least two of polyurethane, acrylic, epoxy resin, and silicone.

4. The battery pack of claim 3, wherein the combination of at least two of polyurethane, acrylic, epoxy resin, and silicone is a compound mixture of the at least two of polyurethane, acrylic, epoxy resin, and silicone.

5. The battery pack of claim 1, wherein each of the plurality of battery cells is a cylindrical lithium-ion battery cell.

6. The battery pack of claim 1, wherein the support structure includes a first end casing and a second end casing, wherein a positive electrode of each battery cell is received in one of the first end casing and the second end casing, and wherein a negative electrode of each battery cell is received in the other of the first end casing and the second casing.

7. The battery pack of claim 6, wherein the plurality of battery cells are stacked in an offset manner along a height and a length of the battery pack, such that the plurality of battery cells defines rows of cells and columns of cells.

8. The battery pack of claim 7, wherein the battery cell potting is only disposed between rows of cells, or only disposed between columns of cells.

9. The battery pack of claim 1, wherein the battery cell potting also encases the circuit board.

10. The battery pack of claim 7, further comprising voids between adjacent battery cells of the plurality of the battery cells.

11. The battery pack of claim 1, wherein the battery cell potting separates the battery cells.

12. A battery pack for an electrical device, the battery pack comprising:
a housing including
a first housing portion,
a second housing portion coupled to the first housing portion,
a cavity, and
at least one terminal configured to electrically connect the battery pack to the electrical device;
a battery cell assembly including
a plurality of battery cells disposed within the cavity and configured to supply power to the electrical device,
a support structure that receives and support the plurality of battery cells within the cavity of the housing, and
a battery cell potting that encases the plurality of battery cells and the support structure; and
a circuit board disposed within the housing atop the plurality of battery cells and including a plurality of electrical components, the circuit board is configured to selectively power the plurality of battery cells,
wherein the circuit board is coupled to the battery cell assembly.

13. The battery pack of claim 12, wherein the battery cell potting is formed of one of polyurethane, acrylic, epoxy resin, and silicone.

14. The battery pack of claim 12, wherein the battery cell potting is formed of a combination of at least two of polyurethane, acrylic, epoxy resin, and silicone.

15. The battery pack of claim 14, wherein the combination of at least two of polyurethane, acrylic, epoxy resin, and silicone is a compound mixture of the at least two of polyurethane, acrylic, epoxy resin, and silicone.

16. The battery pack of claim 12, wherein each of the plurality of battery cells is a cylindrical lithium-ion battery cell.

17. The battery pack of claim 12, wherein the support structure includes a first end casing and a second end casing, and wherein the circuit board is coupled to at least one of the first end casing and the second end casing.

18. A method of manufacturing a battery pack for a power tool, the battery pack including a housing having a first housing portion and a second housing portion that has a plurality of ribs that extend inward toward a cavity of the housing, a battery cell assembly disposed within the cavity of the housing having a plurality of battery cells and a support structure supporting the plurality of battery cells, and a circuit board positioned atop the battery cell assembly within the housing, the method comprising:
injecting battery cell potting around the plurality of battery cells and the support structure, such that the plurality of battery cells and the support structure are coupled together via the battery cell potting; and
forming a plurality of grooves within the battery cell potting that are configured to receive the plurality of the ribs of the housing;
sliding the plurality of grooves along the plurality of ribs to secure the battery cell assembly within the cavity and inhibiting movement of the plurality of battery cells relative to the housing.

19. The method of claim 18, further comprising composing the battery cell potting of a thermal curing adhesive that provides a heat dissipating medium between the plurality of battery cells.

20. The method of claim 18, further comprising forming a plurality of voids between adjacent battery cells of the plurality of battery cells.
